(19) United States
(12) Patent Application Publication
(10) Pub. No.: US 2024/0412052 A1
(43) Pub. Date: Dec. 12, 2024

(54) DATA PROCESSING METHOD AND DATA PROCESSING DEVICE USING SUPPLEMENTED NEURAL NETWORK QUANTIZATION OPERATION

(71) Applicant: SAMSUNG ELECTRONICS CO., LTD., Suwon-si (KR)

(72) Inventors: Meejeong PARK, Suwon-si (KR); Jihun OH, Suwon-si (KR); Youngrae CHO, Suwon-si (KR); Jonghun LEE, Suwon-si (KR)

(73) Assignee: SAMSUNG ELECTRONICS CO., LTD., Suwon-si (KR)

(21) Appl. No.: 18/811,302

(22) Filed: Aug. 21, 2024

Related U.S. Application Data
(63) Continuation of application No. PCT/KR2023/001785, filed on Feb. 8, 2023.

(30) Foreign Application Priority Data
Feb. 22, 2022 (KR) 10-2022-0023210

(51) Int. Cl. G06N 3/0495; G06N 3/0464

(52) U.S. Cl. CPC G06N 3/0495; G06N 3/0464

(57) ABSTRACT

A data processing method for neural network quantization, includes: obtaining a quantized weight by quantizing a weight of a neural network; obtaining a quantization error that is a difference between the weight and the quantized weight; obtaining input data with respect to the neural network; obtaining a first convolution result by performing convolution on the quantized weight and the input data; obtaining a second convolution result by performing convolution on the quantization error and the input data; obtaining a scaled second convolution result by scaling the second convolution result based on bit shifting; and obtaining output data by using the first convolution result and the scaled second convolution result.

### CROSS-REFERENCE TO RELATED APPLICATIONS

This application is a by-pass continuation application of International Application No. PCT/KR2023/001785, filed on Feb. 8, 2023, which is based on and claims priority to Korean Patent Application No. 10-2022-0023210, filed on Feb. 22, 2022, in the Korean Intellectual Property Office, the disclosures of which are incorporated by reference herein in their entireties.

### BACKGROUND

### 1. Field

The disclosure relates to a data processing method and apparatus using neural network quantization. In particular, the disclosure relates to a technology capable of processing data in consideration of quantization errors in quantization operations of artificial intelligence (AI), for example, neural networks.

### 2. Description of Related Art

With the development of artificial intelligence (AI)-related technologies and the development and distribution of hardware for processing data using AI, the need for a method and apparatus for effectively processing data based on neural networks is increasing.

### SUMMARY

According to an aspect of the disclosure, a data processing method for neural network quantization, includes: obtaining a quantized weight by quantizing a weight of a neural network; obtaining a quantization error that is a difference between the weight and the quantized weight; obtaining input data with respect to the neural network; obtaining a first convolution result by performing convolution on the quantized weight and the input data; obtaining a second convolution result by performing convolution on the quantization error and the input data; obtaining a scaled second convolution result by scaling the second convolution result based on bit shifting; and obtaining output data by using the first convolution result and the scaled second convolution result.

The obtaining the quantized weight may include converting the weight from floating-point data into quantized fixed-point data of n-bits.

The obtaining the quantization error may include quantizing the difference.

The obtaining the scaled second convolution result may include determining a bit shift value based on a first scale factor with respect to the weight and a second scale factor with respect to the quantization error.

The obtaining the scaled second convolution result may include determining, based on a magnitude of the quantization error being equal to the first scale factor, the bit shift value to be n-bits, where n denotes a quantization bit value.

The obtaining the scaled second convolution result may include determining, based on a relationship between the first scale factor and the second scale factor being expressed as a square number of 2, the bit shift value to be n+k bits, where n denotes a quantization bit value and k denotes a value of the square number of 2.

The obtaining the scaled second convolution result may include determining, based on the relationship between the first scale factor and the second scale factor not being expressed as the square number of 2, the bit shift value based on k, wherein k is determined through a log operation and a rounding operation.

The obtaining the scaled second convolution result may include determining a range of the first scale factor based on a maximum value and a minimum value of the weight.

The obtaining the scaled second convolution result may include determining a range of the second scale factor based on a maximum value and a minimum value of the quantization error.

The first scale factor may be greater than the second scale factor.

According to an aspect of the disclosure, a data processing apparatus for neural network quantization, includes: a neural processor; and memory storing instructions that, when executed by the neural processor cause the data processing apparatus to: obtain a quantized weight by quantizing a weight of a neural network; obtain a quantization error that is a difference between the weight and the quantized weight; obtain input data with respect to the neural network; obtain a first convolution result by performing convolution on the quantized weight and the input data; obtain a second convolution result by performing convolution on the quantization error and the input data; obtaining a scaled second convolution result by scaling the second convolution result based on a bit shifting; and obtain output data by using the first convolution result and the scaled second convolution result.

The neural processor may be configured to execute the instructions to cause the data processing apparatus to determine a bit shift value based on a first scale factor with respect to the weight and a second scale factor with respect to the quantization error.

The neural processor may be configured to execute the instructions to cause the data processing apparatus to determine, based on a magnitude of the quantization error being equal to the first scale factor, the bit shift value to be n-bits, where n denotes a quantization bit value.

The neural processor may be configured to execute the instructions to cause the data processing apparatus to determine, based on a relationship between the first scale factor and the second scale factor being expressed as a square number of 2, the bit shift value to be n+k bits, where n denotes a quantization bit value and k denotes a value of the square number of 2

The neural processor may be configured to execute the instructions to cause the data processing apparatus to determine, based on the relationship between the first scale factor and the second scale factor not being expressed as the square number of 2, the bit shift value based on k, wherein k is determined through a log operation and a rounding operation.

### DESCRIPTION OF THE DRAWINGS

The above and other aspects, features, and advantages of certain embodiments of the present disclosure are more apparent from the following description taken in conjunction with the accompanying drawings, in which:

FIG. 1 is a diagram for describing processes of outputting data by quantizing a weight of a neural network.

FIG. 2 is a diagram for describing processes of quantizing floating-point data into fixed-point data.

FIG. 3 is a diagram for describing processes of outputting data by using a quantized weight according to the related art.

FIG. 4 is a diagram for describing processes of outputting data by using a quantized weight, a quantization error, and a bit-shift operation according to an embodiment of the disclosure.

FIG. 5A is a diagram for describing processes of outputting data by using a quantized weight and a quantization error according to an embodiment of the disclosure. FIG. 5B is a diagram for describing processes of outputting data by using a quantized weight and a quantization error according to an embodiment of the disclosure. FIG. 5C is a diagram for describing processes of outputting data by using a quantized weight, a quantization error, and a bit-shift operation according to an embodiment of the disclosure.

FIG. 6A is a diagram for describing hardware configuration that does not perform a bit-shift operation according to an embodiment of the disclosure. FIG. 6B is a diagram for describing hardware configuration performing a bit-shift operation according to an embodiment of the disclosure.

FIG. 7 is a flowchart illustrating a data processing method by using a quantized weight, a quantization error, and a bit-shift operation according to an embodiment of the disclosure.

FIG. 8 is a block diagram of a data processing apparatus by using a quantized weight, a quantization error, and a bit-shift operation according to an embodiment of the disclosure.

### DETAILED DESCRIPTION

The embodiments described in the disclosure, and the configurations shown in the drawings, are only examples of embodiments, and various modifications may be made without departing from the scope and spirit of the disclosure.

Throughout the disclosure, the expression “at least one of a, b or c” indicates only a, only b, only c, both a and b, both a and c, both b and c, all of a, b, and c, or variations thereof.

As the disclosure allows for various changes and numerous embodiments, particular embodiments will be illustrated in the drawings and described in detail in the written description. However, this is not intended to limit the disclosure to particular modes of practice, and it is to be appreciated that all modifications, equivalents, and alternatives that do not depart from the spirit and technical scope are encompassed in the disclosure.

As used herein, numbers (e.g., first, second, etc.) used are only identifiers for distinguishing one component from another.

In addition, when an element is referred to as being “connected to” another element, it is to be understood that the element may be directly connected to the other element, but may be connected or connected via another element in the middle, unless otherwise described.

As used herein, regarding an element represented as a “unit” or a “module”, two or more elements may be combined into one element or one element may be divided into two or more elements according to subdivided functions. In addition, each element described hereinafter may additionally perform some or all of functions performed by another element, in addition to main functions of itself, and some of the main functions of each element may be performed entirely by another component.

Also, as used herein, a neural network may include a representative example of an artificial neural network model simulating brain nerves, and is not limited to an artificial neural network model using a specific algorithm. A neural network may also include a deep neural network, for example.

Also, as used herein, a ‘parameter’ includes a value used in an operation process of each layer forming a neural network, and for example, may be used when an input value is applied to a certain operation expression. The parameter includes a value set as a result of training, and may be updated through separate training data when necessary.

Also, as used herein, ‘weight’ includes one of the parameters and includes a value used in a convolution calculation of input data for obtaining output data with respect to a neural network.

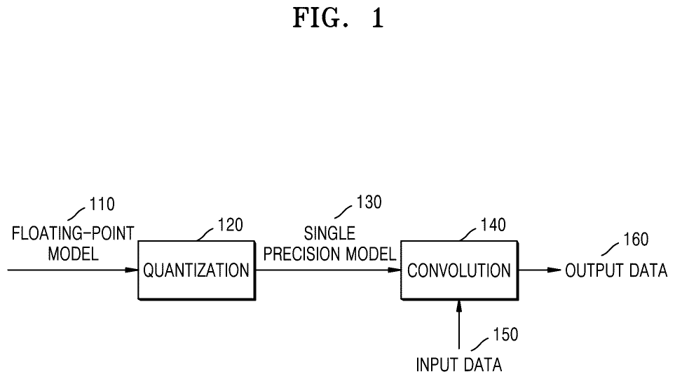

FIG. 1 is a diagram for describing processes of outputting data by quantizing a weight of a neural network.

Referring to FIG. 1, a procedure of processing data by using a trained neural network includes acquiring single precision model 130 data, that is, a quantized weight of a neural network expressed in 32-bits, by quantizing a floating-point model 110, and acquiring output data 160 through a convolution 140 of single precision model 130 data and input data 150 to the neural network.

‘Floating point’ is a method of expressing a number using a significand and an exponent without fixing a position of a decimal point on a computer, and ‘fixed-point’ is a method of expressing a number by using a decimal point of fixed position on the computer. In a restricted memory, only numbers of a narrower range may be represented in fixed-point as compared with floating-point.

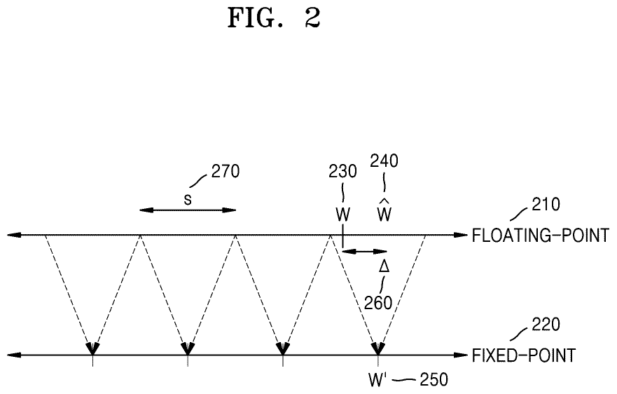

That is, expressing numbers and data in floating-point may be more expensive as compared with the fixed-point, and thus, it is necessary to quantize data expressed in floating-point into fixed-point in a low-precision neural network processing unit (NPU). FIG. 2 that is described later illustrates a process of quantizing from floating-point into fixed-point.

FIG. 2 is a diagram for describing processes of quantizing floating-point data into fixed-point data.

Referring to FIG. 2, in order to quantize a weight w 230 expressed in a floating-point 210 into a weight w′ 250 expressed in a fixed-point 220, the weight w 230 in the floating-point is mapped to a weight ŵ 240 corresponding to the weight w′ 250 in the floating-point. Accordingly, a quantization error Δ 260 occurs between the weight w 230 in floating-point and the weight ŵ 240 corresponding to the quantized weight w′ 250.

Here, in order to express consecutive weights in floating-point in values of n-bits, a scale factor(s) 270 is expressed as one value by Equation 1 below based on a range of a minimum value and a maximum value of the weight.

$$scale ( {s}_{w} ) = \frac{max - min}{{2}^{n} - 1} \qquad [ Equation 1 ]$$

Accordingly, the quantized weight w′ in fixed-point may be expressed as one of 2ⁿ values by Equation 2 below.

$${w}^{′} = \frac{w}{{s}_{w}} \qquad [ Equation 2 ]$$

In addition, the weight ŵ in floating-point corresponding to the quantized weight is expressed by Equation 3 below.

$$\hat{w} = {s}_{w} * {w}^{′} \qquad [ Equation 3 ]$$

Also, the quantization error (Δ) 260 occurring due to the quantization is expressed by Equation 4 below.

$$Δ = w - \hat{w} \qquad [ Equation 4 ]$$

Also, a scale s_{Δ} of the quantization error (Δ) 260 is determined based on the maximum value and the minimum value of the quantization errors, and thus, is determined to be a value between

$$[ 0 , \frac{scale ( {s}_{w} )}{{2}^{n} - 1} ] .$$

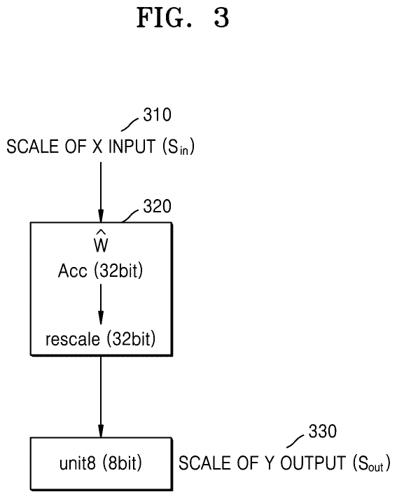

FIG. 3 is a diagram for describing processes of outputting data by using quantized weights according to the related art.

Output data y obtained through a convolution calculation using a weight w of a neural network and input data x may be generally expressed by Equation 5 below.

$$y = \sum ( w * x ) + bias \qquad [ Equation 5 ]$$

Referring to FIG. 3, the convolution operation is expressed as a quantization convolution operation as in Equation 6 below, by using an x input scale factor sᵢₙ 310 of quantized input data and a y output scale factor sₒᵤₜ 330 of quantized output data.

$${y}^{′} = \frac{{s}_{i n} * {s}_{w}}{{s}_{out}} \sum ( {w}^{′} * {x}^{′} ) + bias \qquad [ Equation 6 ]$$

Equation 6 above is of the same type as a general convolution operation, but after the operation using the quantization weight w′ and input x′, the entire scale

$$( \frac{{s}_{i n} * {s}_{w}}{{s}_{out}} )$$

is reflected.

In detail, in the quantization convolution 320, after an accumulate operation of the quantized input data and the weight is carried out in single precision, a rescaling is performed by using the entire scale

$$( \frac{{s}_{i n} * {s}_{w}}{{s}_{out}} )$$

value that reflects the scale of the quantized input, weight, and output.

However, due to the quantization convolution operation, a quantization error Δ occurs between the weight w expressed in floating-point and ŵ 320 in floating-point, which corresponds to the quantized weight w′, and the error as much as the quantization error Δ is not corrected, and thus, there is a difference from the result of the existing convolution.

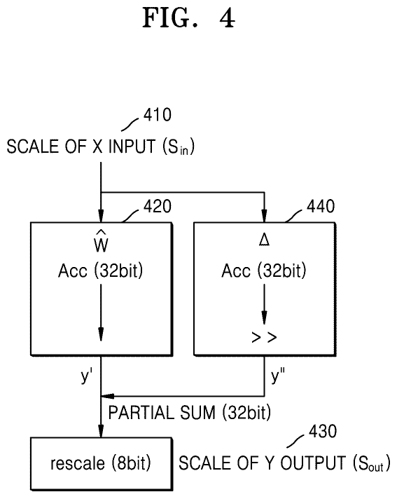

FIG. 4 illustrates a modified partial sum quantization convolution operation for supplementing the quantization error.

FIG. 4 is a diagram for describing processes of outputting data by using a quantized weight, a quantization error, and a bit-shift operation according to an embodiment.

Referring to FIG. 4, a partial sum operation is performed by using an additional operation 440 with respect to the quantization error, besides the quantization convolution 420 operation, and then, a supplemented convolution operation as in Equation 7 is performed by using an x input scale factor sᵢₙ 410 of the quantized input data and a y output scale factor sₒᵤₜ 430 of the quantized output data.

$${y}^{′} = \frac{{s}_{i n} * {s}_{w}}{{s}_{out}} \sum ( {w}^{′} * {x}^{′} + \frac{{s}_{Δ}}{{s}_{w}} * ( {Δ}^{′} * {x}^{′} ) ) + bias \qquad [ Equation 7 ]$$

As in Equation 7 above, the quantization convolution operation is supplemented by adding

$$\frac{{s}_{Δ}}{{s}_{w}} * ( {Δ}^{′} * {x}^{′} )$$

to the quantization convolution as in Equation 6 above according to the related art.

In order to reflect the total scale of the quantization convolution while reflecting the value Δ′ obtained by quantizing the quantization error Δ and the scale factor s_{Δ} of the quantization error, the scale for the quantization error Δ is expressed in an existing weight scale factor s_{w}.

In order to correct the added part about the quantization error in Equation 7 above by modifying an existing partial sum convolution, the scale

$$\frac{{s}_{Δ}}{{s}_{w}}$$

of the partial sum convolution is expressed as a shift scale that is a bit operator that is effective for hardware operation. That is, a bit shift operation based on the scale

$$\frac{{s}_{Δ}}{{s}_{w}}$$

is performed on the convolution operation result of the quantization error and the input data of the neural network.

Accordingly, the operation on the added quantization error in Equation 7 above may be expressed according to three cases.

First, when it is assumed that s_{Δ} is a maximum value, a case in which the scale of the quantization error Δ is the largest is the same case as that in which the difference between w and ŵ has the same range as that of the scale of the existing weight, that is, the magnitude Δ of the quantization error is the same as the existing weight scale s_{w}, and thus, s_{Δ} may be expressed as Equation 8 below.

$${s}_{Δ} = \frac{{s}_{w}}{{2}^{n} - 1} \qquad [ Equation 8 ]$$

Accordingly, the bit scale value is determined to be an n-bit shift scale value according to Equation 9 below.

$$\frac{{s}_{Δ}}{{s}_{w}} = \frac{{s}_{w}}{( {2}^{n} - 1 ) * {s}_{w}} = \frac{1}{{2}^{n} - 1} \qquad [ Equation 9 ]$$

Next, when the relationship between s_{Δ} and s_{w} may be expressed as a square number of 2, the bit scale value is determined to be an n+k bit shift scale value according to Equation 10 below.

$$\frac{{s}_{Δ}}{{s}_{w}} = \frac{{s}_{w}}{{2}^{k} * ( {2}^{n} - 1 ) * {s}_{w}} = \frac{1}{{2}^{k} * ( {2}^{n} - 1 )} \qquad [ Equation 10 ]$$

Last, when the relationship between s_{Δ} and s_{w} may not be expressed as a square number of 2, a log operation and a rounding operation are applied to s_{Δ} and s_{w} to obtain k as shown in Equation 11 below.

$$k = round ( log 2 ( \frac{{s}_{w}}{{s}_{Δ}} ) ) \qquad [ Equation 11 ]$$

s_{Δ} is re-defined as

$$\frac{{s}_{w}}{{2}^{k} * ( {2}^{n} - 1 )}$$

according to the shift scale by using k obtained by Equation 11 above, and nudge minimum value and maximum value are defined within the range of the newly defined quantization error Δ, and thus, the bit scale value may be determined to be an n+k bit shift scale value according to Equation 12 below.

$$\frac{{s}_{Δ}}{{s}_{w}} = \frac{{s}_{w}}{{2}^{k} * ( {2}^{n} - 1 ) * {s}_{w}} = \frac{1}{{2}^{k} * ( {2}^{n} - 1 )} \qquad [ Equation 12 ]$$

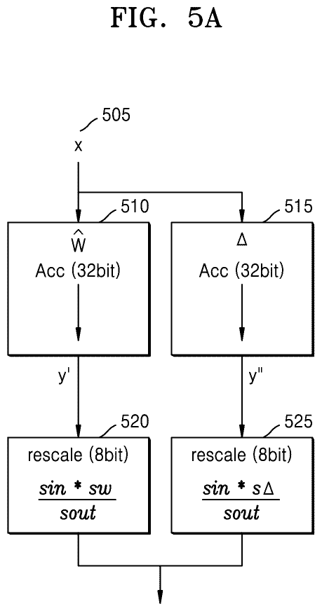

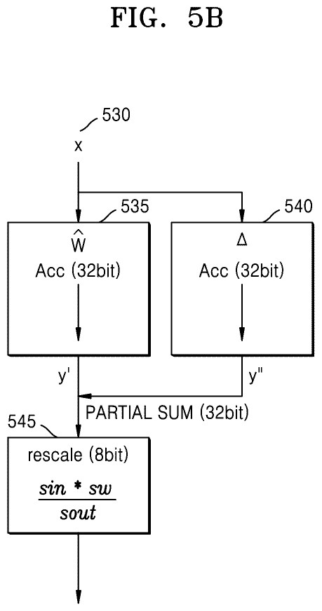

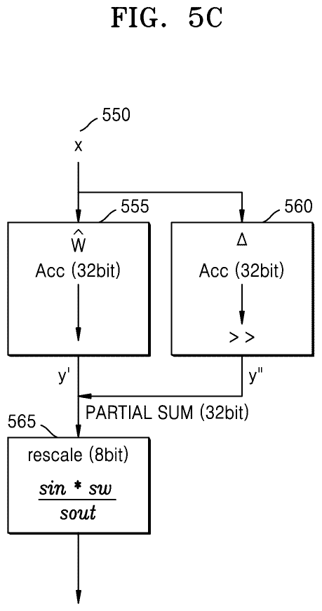

FIGS. 5A and 5B describe issues in an embodiment, in which the bit shift operation is not performed, and FIG. 5C describes advantages according to an embodiment of the disclosure.

FIG. 5A is a diagram for describing processes of outputting data by using a quantized weight and a quantization error according to an embodiment of the disclosure. FIG. 5B is a diagram for describing processes of outputting data by using a quantized weight and a quantization error according to an embodiment of the disclosure. FIG. 5C is a diagram for describing processes of outputting data by using a quantized weight, a quantization error, and a bit-shift operation according to an embodiment of the disclosure.

Referring to FIG. 5A, an output value obtained by performing accumulate operation (510) of input data 505 and a quantization weight and then rescaling (520) as a rescale value

$$\frac{{s}_{i n} * {s}_{w}}{{s}_{out}}$$

and an output value obtained by performing accumulate operation (515) of the input data 505 with the quantization error and rescaling (525) as a rescale value

$$\frac{{s}_{i n} * {s}_{Δ}}{{s}_{out}}$$

are added to obtain output data.

The structure of FIG. 5A is the same as the result of using the existing convolution twice, not the partial sum convolution, and the quantization error may not be corrected because there is a large loss in the quantization error Δ value as the quantized value, not the sum, is added during the accumulate operation.

Referring to FIG. 5B, output data is obtained by performing accumulate operation of input data 530 with the quantization weight, performing the accumulate operation of the input data 530 with the quantization error, and then, performing rescaling (545) as a rescale value

$$\frac{{s}_{i n} * {s}_{w}}{{s}_{out}} .$$

The structure of FIG. 5B may derive a wrong accumulate operation value because the scale of quantization error Δ is not reflected.

Referring to FIG. 5C, output data is obtained by performing accumulate operation (555) of input data 550 with quantization weight, performing the accumulate operation and bit shift operation (560) of the input data 550 with quantization error, and then, performing rescaling (565) as the rescale value

$$\frac{{s}_{i n} * {s}_{w}}{{s}_{out}} .$$

According to the structure of FIG. 5C, the scale of the quantization error Δ is reflected, and thus, a value with appropriately corrected quantization error with the precision of an existing neural processing unit (NPU) may be derived.

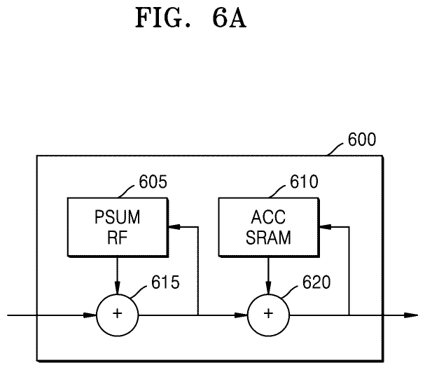

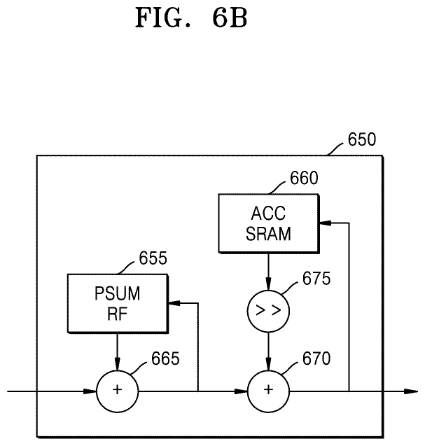

FIG. 6A is a diagram for describing hardware configuration that does not perform a bit-shift operation, according to an embodiment of the disclosure. FIG. 6B is a diagram for describing hardware configuration performing a bit-shift operation, according to an embodiment of the disclosure.

Referring to FIG. 6A, in a hardware structure 600, a PSUM RF 605 performing partial summing consequently performs the partial sum and adds (615), and the added values are summed (620) in an ACC SRAM 610 performing an accumulation operation and processed. All of hardware operators may not process all accumulation result values at once, and thus, intermediate results are stored in the ACC SRAM by using a partial sum convolution, and previously accumulated values and current calculated value are accumulated to derive a result. Here, the PSUM RF 605 and the ACC SRAM 610 are hardware (e.g., memory) respectively performing the partial sum and accumulation operation, and are titled according to functions thereof, and are not limited thereto.

Referring to FIG. 6B, the partial sum convolution used to accumulate the intermediate results is corrected by reflecting quantization errors through a slight deformation, that is, a very small hardware logic change. In the case of rescaling using a multiplier or divider operator, there is no benefit of hardware due to high costs or large area, whereas the bit shift operation is low in costs or area.

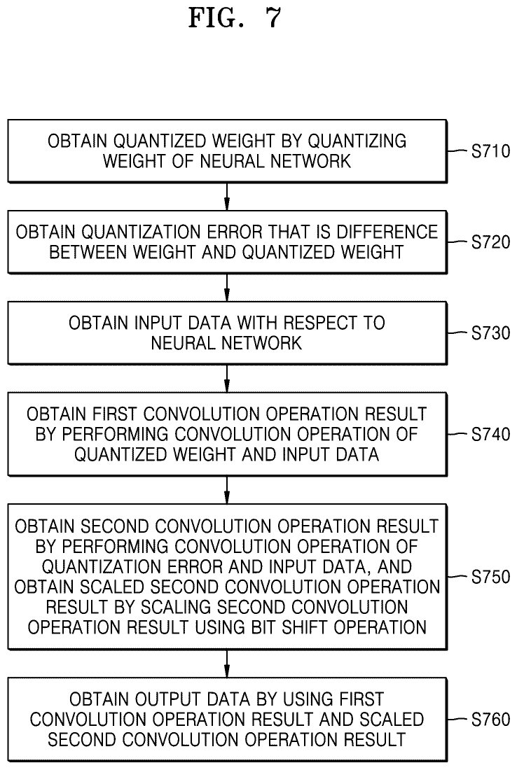

FIG. 7 is a flowchart illustrating a data processing method by using a quantized weight, a quantization error, and a bit-shift operation according to an embodiment.

In operation S710, a data processing apparatus 800 obtains a quantized weight by quantizing a weight of a neural network.

According to an embodiment, the quantization may be an operation of converting floating-point data into quantized fixed-point data of n-bits.

In operation S720, the data processing apparatus 800 obtains quantization error that is a difference between the weight and the quantized weight.

According to an embodiment, the quantization error may be obtained by performing quantization on the difference between the weight and the quantized weight.

In operation S730, the data processing apparatus 800 obtains input data with respect to the neural network.

In operation S740, the data processing apparatus 800 obtains a first convolution operation result by performing a convolution operation of the quantized weight and the input data.

In operation S750, the data processing apparatus 800 obtains a second convolution operation result by performing a convolution operation of the quantized error and the input data, and obtains a scaled second convolution operation result by scaling the second convolution operation result by using the bit shift operation.

According to an embodiment, a bit shift value in the bit shift operation may be determined based on a first scale factor with respect to the weight and a second scale factor with respect to the quantization error.

According to an embodiment, when the magnitude of the quantization error is equal to the first scale factor, the bit shift value is determined to be n-bits, where n may denote a quantization bit value.

According to an embodiment, when a relationship between the first scale factor and the second scale factor is expressed in the square number of 2, the bit shift value is determined to be n+k bits, where n denotes a quantization bit value and k denote a value of the square number of 2.

According to an embodiment, when the relationship between the first scale factor and the second scale factor is not expressed as the square number of 2, the bit shift value may be determined based on k that is determined through a log operation and a rounding operation.

According to an embodiment, a range of the first scale factor may be determined based on a maximum value and a minimum value of the weight.

According to an embodiment, a range of the second scale factor may be determined based on a maximum value and a minimum value of the quantization error.

According to an embodiment, the first scale factor may be greater than the second scale factor.

In operation S760, the data processing apparatus 800 obtains output data by using the first convolution operation result and the scaled second convolution operation result.

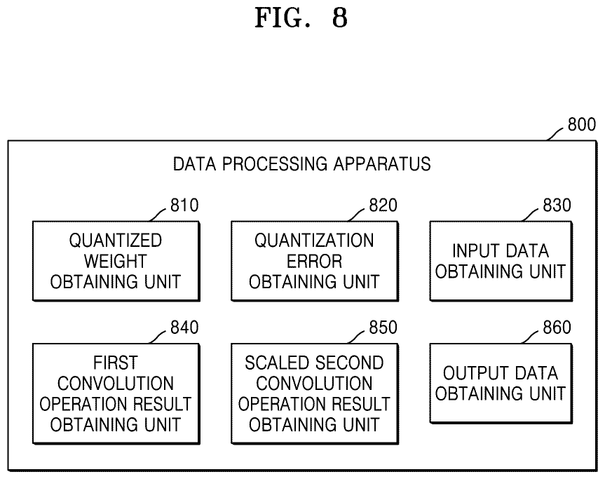

FIG. 8 is a block diagram of a data processing apparatus by using quantized weights, quantization error, and bit-shift operation according to an embodiment.

Referring to FIG. 8, the data processing apparatus 800 includes a quantization weight obtaining unit 810, a quantization error obtaining unit 820, an input data obtaining unit 830, a first convolution operation result obtaining unit 840, a scaled second convolution operation result obtaining unit 850, and an output data obtaining unit 860.

The quantization error obtaining unit 810, the quantization error obtaining unit 820, the input data obtaining unit 830, the first convolution operation result obtaining unit 840, the scaled second convolution operation result obtaining unit 850, and the output data obtaining unit 860 may be implemented as a neural processor, and the quantization weight obtaining unit 810, the quantization error obtaining unit 820, the input data obtaining unit 830, the first convolution operation result obtaining unit 840, the scaled second convolution operation result obtaining unit 850, and the output data obtaining unit 860 may operate according to instructions stored in a memory.

In FIG. 8, the quantization error obtaining unit 810, the quantization error obtaining unit 820, the input data obtaining unit 830, the first convolution operation result obtaining unit 840, the scaled second convolution operation result obtaining unit 850, and the output data obtaining unit 860 are individually shown, but the quantization weight obtaining unit 810, the quantization error obtaining unit 820, the input data obtaining unit 830, the first convolution operation result obtaining unit 840, the scaled second convolution operation result obtaining unit 850, and the output data obtaining unit 860 may be implemented via one processor. In this case, the quantization weight obtaining unit 810, the quantization error obtaining unit 820, the input data obtaining unit 830, the first convolution operation result obtaining unit 840, the scaled second convolution operation result obtaining unit 850, and the output data obtaining unit 860 may be implemented by exclusive processor, or may be implemented through a combination of a universal processor such as an application processor (AP), a central processing unit (CPU), a graphic processing unit (GPU), or an NPU and software. Also, the exclusive processor may include a memory for implementing the embodiment of the disclosure or a memory processor for using an external memory.

The quantization weight obtaining unit 810, the quantization error obtaining unit 820, the input data obtaining unit 830, the first convolution operation result obtaining unit 840, the scaled second convolution operation result obtaining unit 850, and the output data obtaining unit 860 may be implemented as a plurality of processors. In this case, the above components may be implemented as a combination of the exclusive processors or may be implemented through a combination of the plurality of processors such as AP, CPU, GPU, or NPU and software.

The quantization weight obtaining unit 810 obtains a quantized weight by quantizing the weight of the neural network.

The quantization error obtaining unit 820 obtains a quantized error that is a difference between the weight and the quantized weight.

The input data obtaining unit 830 obtains input data to the neural network.

The first convolution operation result obtaining unit 840 obtains a first convolution operation result by performing a convolution operation of the quantized weight and the input data.

The scaled second convolution operation result obtaining unit 850 obtains a second convolution operation result by performing a convolution operation of the quantized error and the input data, and obtains a scaled second convolution operation result by scaling the second convolution operation result by using the bit shift operation.

The output data obtaining unit 860 obtains output data by using the first convolution operation result and the scaled second convolution operation result.

The data processing method using supplemented neural network quantization operation according to an embodiment of the disclosure may include: obtaining quantized weight by quantizing a weight of a neural network; obtaining a quantization error that is a difference between the weight and the quantized weight; obtaining input data with respect to the neural network; obtaining a first convolution operation result by performing a convolution operation of the quantized weight and the input data; obtaining a second convolution operation result by performing a convolution operation of the quantization error and the input data, and obtaining a scaled second convolution operation result by scaling the second convolution operation result using a bit shift operation; and obtaining output data by using the first convolution operation result and the scaled second convolution operation result.

According to an embodiment of the disclosure, the quantization may be an operation of converting floating-point data into quantized fixed-point data of n-bits.

According to an embodiment of the disclosure, the quantization error may be obtained by performing quantization on the difference.

According to an embodiment of the disclosure, a bit shift value in the bit shift operation may be determined based on a first scale factor with respect to the weight and a second scale factor with respect to the quantization error.

According to an embodiment of the disclosure, when the magnitude of the quantization error is equal to the first scale factor, the bit shift value is determined to be n-bits, and n may denote a quantization bit value.

According to an embodiment of the disclosure, when a relationship between the first scale factor and the second scale factor is expressed in the square number of 2, the bit shift value is determined to be n+k bits, where n denotes a quantization bit value and k denote a value of the square number of 2.

According to an embodiment of the disclosure, when the relationship between the first scale factor and the second scale factor is not expressed as the square number of 2, the bit shift value may be determined based on k that is determined through a log operation and a rounding operation.

According to an embodiment of the disclosure, a range of the first scale factor may be determined based on a maximum value and a minimum value of the weight.

According to an embodiment of the disclosure, a range of the second scale factor may be determined based on a maximum value and a minimum value of the quantization error.

According to an embodiment of the disclosure, the first scale factor may be greater than the second scale factor.

The data processing method using supplemented neural network quantization operation according to an embodiment of the disclosure may show high-precision effects in a convolution operation of an NPU supporting low precision by using the quantization error. In detail, the precision is maintained as much as the bits of high precision by correcting the error that is generated due to the quantization of the neural network weight in an actual NPU, and effects of optimizing operation amount and memory may be simultaneously obtained while maintaining the accuracy shown in the high precision in an NPU convolution operation of low precision.

The data processing apparatus using the supplemented neural network quantization operation according to an embodiment of the disclosure includes: a memory; and a neural processor, wherein the neural processor may obtain quantized weight by quantizing a weight of a neural network; obtain a quantization error that is a difference between the weight and the quantized weight; obtain input data with respect to the neural network, obtain a first convolution operation result by performing a convolution operation of the quantized weight and the input data, obtain a second convolution operation result by performing a convolution operation of the quantization error and the input data, and obtain a scaled second convolution operation result by scaling the second convolution operation result using a bit shift operation, and obtain output data by using the first convolution operation result and the scaled second convolution operation result.

According to an embodiment of the disclosure, the quantization may be an operation of converting floating-point data into quantized fixed-point data of n-bits.

According to an embodiment of the disclosure, the quantization error may be obtained by performing quantization on the difference.

According to an embodiment of the disclosure, a bit shift value in the bit shift operation may be determined based on a first scale factor with respect to the weight and a second scale factor with respect to the quantization error.

According to an embodiment of the disclosure, when the magnitude of the quantization error is equal to the first scale factor, the bit shift value is determined to be n-bits, and n may denote a quantization bit value.

According to an embodiment of the disclosure, when a relationship between the first scale factor and the second scale factor is expressed in the square number of 2, the bit shift value is determined to be n+k bits, where n denotes a quantization bit value and k denote a value of the square number of 2.

According to an embodiment of the disclosure, when the relationship between the first scale factor and the second scale factor is not expressed as the square number of 2, the bit shift value may be determined based on k that is determined through a log operation and a rounding operation.

According to an embodiment of the disclosure, a range of the first scale factor may be determined based on a maximum value and a minimum value of the weight.

According to an embodiment of the disclosure, a range of the second scale factor may be determined based on a maximum value and a minimum value of the quantization error.

According to an embodiment of the disclosure, the first scale factor may be greater than the second scale factor.

The data processing apparatus using supplemented neural network quantization operation according to an embodiment of the disclosure may show high-precision effects in a convolution operation of an NPU supporting low precision by using the quantization error. In detail, the precision is maintained as much as the bits of high precision by correcting the error that is generated due to the quantization of the neural network weight in an actual NPU, and effects of optimizing operation amount and memory may be simultaneously obtained while maintaining the accuracy shown in the high precision in an NPU convolution operation of low precision.

The machine-readable storage medium may be provided in the form of a non-transitory storage medium. Here, the term ‘non-transitory’ simply means that the storage medium is a tangible device, and does not include a signal (e.g., an electromagnetic wave), but this term does not differentiate between where data is semi-permanently stored in the storage medium and where the data is temporarily stored in the storage medium. For example, the ‘non-transitory storage medium’ may include a buffer in which data is temporarily stored.

According to an embodiment, the method according to various embodiments disclosed in the present document may be provided to be included in a computer program product. The computer program product may be traded between a seller and a buyer as a product. The computer program product may be distributed in the form of a machine-readable storage medium e.g., compact disc read only memory (CD-ROM)), or be distributed (e.g., downloaded or uploaded) online via an application store, or between two user devices (e.g., smart phones) directly. If distributed online, at least part of the computer program product (e.g., downloadable app) may be temporarily generated or at least temporarily stored in the machine-readable storage medium, such as memory of the manufacturer's server, a server of the application store, or a relay server.

What is claimed is:

1. A data processing method for neural network quantization, comprising:
obtaining a quantized weight by quantizing a weight of a neural network;
obtaining a quantization error that is a difference between the weight and the quantized weight;
obtaining input data with respect to the neural network;
obtaining a first convolution result by performing convolution on the quantized weight and the input data;
obtaining a second convolution result by performing convolution on the quantization error and the input data;
obtaining a scaled second convolution result by scaling the second convolution result based on bit shifting; and
obtaining output data by using the first convolution result and the scaled second convolution result.

2. The data processing method of claim 1, wherein the obtaining the quantized weight comprises converting the weight from floating-point data into quantized fixed-point data of n-bits.

3. The data processing method of claim 1, wherein the obtaining the quantization error comprises quantizing the difference.

4. The data processing method of claim 1, wherein the obtaining the scaled second convolution result comprises determining a bit shift value based on a first scale factor with respect to the weight and a second scale factor with respect to the quantization error.

5. The data processing method of claim 4, wherein, the obtaining the scaled second convolution result comprises determining, based on a magnitude of the quantization error being equal to the first scale factor, the bit shift value to be n-bits, where n denotes a quantization bit value.

6. The data processing method of claim 4, wherein, the obtaining the scaled second convolution result comprises determining, based on a relationship between the first scale factor and the second scale factor being expressed as a square number of 2, the bit shift value to be n+k bits, where n denotes a quantization bit value and k denotes a value of the square number of 2.

7. The data processing method of claim 6, wherein, the obtaining the scaled second convolution result comprises determining, based on the relationship between the first scale factor and the second scale factor not being expressed as the square number of 2, the bit shift value based on k, wherein k is determined through a log operation and a rounding operation.

8. The data processing method of claim 4, wherein the obtaining the scaled second convolution result comprises determining a range of the first scale factor based on a maximum value and a minimum value of the weight.

9. The data processing method of claim 4, wherein the obtaining the scaled second convolution result comprises determining a range of the second scale factor based on a maximum value and a minimum value of the quantization error.

10. The data processing method of claim 4, wherein the first scale factor is greater than the second scale factor.

11. A data processing apparatus for neural network quantization, comprising:
a neural processor; and
memory storing instructions that, when executed by the neural processor cause the data processing apparatus to:
obtain a quantized weight by quantizing a weight of a neural network;
obtain a quantization error that is a difference between the weight and the quantized weight;
obtain input data with respect to the neural network;
obtain a first convolution result by performing convolution on the quantized weight and the input data;
obtain a second convolution result by performing convolution on the quantization error and the input data;
obtaining a scaled second convolution result by scaling the second convolution result based on a bit shifting; and
obtain output data by using the first convolution result and the scaled second convolution result.

12. The data processing apparatus of claim 11, wherein the neural processor is configured to execute the instructions to cause the data processing apparatus to determine a bit shift value based on a first scale factor with respect to the weight and a second scale factor with respect to the quantization error.

13. The data processing apparatus of claim 12, wherein, the neural processor is configured to execute the instructions to cause the data processing apparatus to determine, based on a magnitude of the quantization error being equal to the first scale factor, the bit shift value to be n-bits, where n denotes a quantization bit value.

14. The data processing apparatus of claim 12, wherein, the neural processor is configured to execute the instructions to cause the data processing apparatus to determine, based on a relationship between the first scale factor and the second scale factor being expressed as a square number of 2, the bit shift value to be n+k bits, where n denotes a quantization bit value and k denotes a value of the square number of 2.

15. The data processing apparatus of claim 14, wherein, the neural processor is configured to execute the instructions to cause the data processing apparatus to determine, based on the relationship between the first scale factor and the second scale factor not being expressed as the square number of 2, the bit shift value based on k, wherein k is determined through a log operation and a rounding operation.
